(19) United States
(12) Patent Application Publication
(10) Pub. No.: US 2026/0309109 A1
(43) Pub. Date: Oct. 8, 2026

(54) FUEL INJECTION ARRANGEMENT FOR HAND-HELD POWERTOOLS

(71) Applicant: HUSQVARNA AB, Huskvarna (SE)

(72) Inventors: Niklas SUNDBERG, Alingsas (SE); Bo CARLSSON, Alingsas (SE)

(21) Appl. No.: 19/713,885

(22) Filed: Jun. 19, 2026

Related U.S. Application Data
(63) Continuation of application No. 18/870,884, filed on May 25, 2023.

(30) Foreign Application Priority Data
May 30, 2022 (SE) 2250642-2
May 30, 2022 (SE) 2250643-0
Dec. 5, 2022 (SE) 2251418-6

(51) Int. Cl. F02M 61/14; F02M 35/10; F02M 69/04

(52) U.S. Cl. CPC F02M 61/145; F02M 35/1017; F02M 35/1019; F02M 35/10216; F02M 69/044

(57) ABSTRACT

Hand-held power tool including a crankcase scavenged combustion engine arranged to drive a work tool, where a fuel injector is configured to provide a controlled amount of fuel into an air and fuel intake flow of the combustion engine, and where an idling air flow channel is arranged to connect with the air and fuel intake flow of the combustion engine in connection to the fuel injector.

### TECHNICAL FIELD

The present disclosure relates to improved fuel injection arrangements, and control thereof, for use in hand-held power tools such as power cutters, chain saws, and other powertools.

### BACKGROUND

Power cutters are hand-held construction equipment designed for cutting hard materials such as concrete and stone by a rotatable abrasive cutting disc. Power cutters are often driven by crankcase scavenged two-stroke combustion engines.

Chain saws are also often driven by crankcase scavenged two-stroke combustion engines. A chain saw can be used to cut both wood and concrete, depending on the type of chain used on the saw.

Conventional carburettor designs are commonly seen in these types of appliances. However, fuel injection systems comprising fuel injectors fed by fuel pumps are becoming increasingly common on both power cutters and chain saws, as well as on other types of hand-held power tools.

EP2602470 discloses an example crankcase scavenged two-stroke engine with fuel injection directly into the crankcase.

EP2414665 describes another example crankcase scavenged two-stroke engine with fuel injection directly into the combustion chamber.

Despite the progress made to-date, there is a desire for further improvements in power tools such as construction equipment for processing concrete and stone, as well as in power tools for processing softer materials like wood.

### SUMMARY

It is an objective of the present disclosure to provide improved fuel systems for hand-held power tools such as power cutters, chain saws, and other power tools. The objective is at least in part obtained by the features set out in the appended claims.

The objective may at least in part be obtained by power tools such as handheld construction equipment that comprises a crankcase scavenged combustion engine arranged to drive a work tool. A first mass of the equipment comprises the combustion engine and a second mass of the equipment is vibrationally decoupled from the first mass by means of one or more resilient members. A fuel injector fed by a fuel pump is configured to provide a controlled amount of fuel into the air and fuel intake flow of the combustion engine. The fuel injector is arranged in the second mass and thus separated from the first mass by the one or more resilient members. This means that the fuel injector is distanced from the high temperature combustion engine, which is an advantage. The fuel injector is also subject to a reduced amount of vibration compared to if it had been mounted, e.g., directly onto the crankcase of the combustion engine. The fuel injector may be separated from the combustion engine by a few centimeters or more, such as more than 3 cm or even more than 5 cm.

The second mass of the equipment may comprise at least one handle by which an operator guides the equipment during use. This is a common division between vibrating and non-vibrating parts of a power cutter. By arranging the fuel injector in the handle part of the machine, it is subject to lower temperatures and less vibration. The fuel injector arrangement may also be arranged in a smaller second mass that essentially only comprises the fuel injector sub-system. In this case the equipment optionally also comprises a third mass vibrationally decoupled from at least one of the first mass and the second mass, where the third mass comprises the at least one handle by which an operator guides the equipment during use.

The air and fuel intake flow of the combustion engine optionally passes from the second mass to the first mass via a non-rigid tubular conduit. This non-rigid conduit does not forward much vibration from the first mass to the second mass, and it also makes it easier to assemble the fuel system connections between first and second masses. The non-rigid tubular conduit is also less sensitive to vibration, which may otherwise cause material fatigue in rigid conduit connections and the like. An integrally formed fuel system module comprising the injector and other related parts may be assembled separately and mounted in the hand-held power tool by attaching the non-rigid tubular conduit in a convenient manner.

The fuel injector is preferably integrated in a valve housing part together with a throttle valve of the hand-held power tool. Thus, a fuel and air sub-system can be formed which can be assembled separately from the rest of the machine and efficiently mounted in one piece. The integrated valve housing part is also possible to design in a spatially efficient manner, which is an advantage in hand-held power tools and construction equipment, where space is often scarce.

At least one airhead channel, i.e., a conduit for pure air into the combustion engine, optionally extends from the second mass over to the first mass, where the fuel injector is arranged in connection to the at least one airhead channel. First and second airhead channels preferably extend from the second mass over to the first mass and the fuel injector is advantageously arranged in between the first and second airhead channels, where it receives cooling and is arranged in a compact spatially efficient manner. The integrated valve housing may optionally also comprise the one or more airhead channels. The airhead channel or channels can optionally be controlled by the same throttle valve as the air and fuel intake flow, providing a particularly compact design.

The fuel injector can be mounted on an upper or a lower side of the fuel intake flow conduit. In case the fuel injector is mounted on an upward side of the air and fuel intake flow of the combustion engine, the controlled amount of fuel is injected in a downward direction when the equipment is held in a normal operating position. This means that gravity aids the flow of fuel from the fuel injector nozzle and into the air and fuel intake of the combustion engine. In case the fuel injector is mounted on a downward side of the air and fuel intake flow of the combustion engine, the controlled amount of fuel is injected in a direction having a component in the upwards direction when the equipment is held in a normal operating position. This mounting of the fuel injector may be suitable due to overall machine geometry. It is an advantage that the placement of the fuel injector in the second mass can be selected relatively freely.

An electronic control unit (ECU) configured to control the fuel injector is preferably also arranged in the second mass where the cooling requirements are somewhat relaxed and where the ECU is also subject to less vibration which could be harmful to the electrical connectors and circuits of the ECU.

At least one fuel line extending from a fuel pump of the power tool to the fuel injector may also be enclosed in the second mass, where it is protected from strong vibration.

The present disclosure also relates to an idling air channel which is arranged to connect with the air and fuel intake flow of the combustion engine downstream from the throttle valve and in connection to the fuel injector. This idling air channel provides a constant air flow when the machine is in operation which both draws the fuel from the fuel injector towards the combustion engine, and also cools the fuel injector. To improve the cooling effect, the idling air channel can be guided along a part of the fuel injector prior to connecting with the air and fuel intake flow of the combustion engine. This prolongs the contact time between idling air and the fuel injector, thereby improving the heat transfer between fuel injector and idling air flow. To further improve the cooling effect, the fuel injector optionally comprises a cooling flange portion, and the idling air channel is guided along the cooling flange portion prior to connecting with the air and fuel intake flow of the combustion engine. The cooling flange portion preferably forms part of the idling channel wall, such that the idling air flow passes the cooling flange of the fuel injector.

A control valve can also be arranged in the idling air channel to adjust the air flow of the idling air channel. This control valve can of course be manually operated. However, additional advantages can be obtained if the control valve is arranged to be adjusted based on a control signal from an ECU of the equipment. This way an automatic optimization of idling operation by the combustion engine can be implemented. The control valve can also be used to open up the idling air channel in preparation for combustion engine start when an increased amount of air can be beneficial. Once the combustion engine has started and is running properly the idling air channel reverts back to its nominal idling air flow state. The hand-held power tool may for instance comprise an electronically controlled idle screw arranged to control an air flow in an idling air flow channel based on a control signal from a control unit such as the above-mentioned ECU. The control unit can then increase the air flow in the idling air flow channel by the electronically controlled idle screw during the start operation to improve start performance of the combustion engine.

The hand-held power tool optionally comprises an electronically controlled throttle valve arranged to control the air and fuel intake flow to the combustion engine based on a control signal from a control unit such as the ECU mentioned above. This electronically controlled throttle valve can be used to optimize various operations of the power tool, as described in WO2020027708A1 and elsewhere in the prior art.

The ECU may be arranged to restrict the air and fuel intake flow to the combustion engine by the electronically controlled throttle valve in case the combustion engine speed does not meet an engine speed acceptance criterion, such as if the combustion engine speed goes above a predetermined maximum engine speed threshold. This function is often referred to as a cut-out function, and can be conveniently implemented in this manner.

The ECU may also be arranged to increase the air and fuel intake flow to the combustion engine above an idling air flow level by the electronically controlled throttle valve during start of the combustion engine.

The electronically controlled throttle valve is advantageously arranged in series with a manually controlled throttle valve to control the air and fuel intake flow to the combustion engine. By arranging the two throttle valves in series a measure of redundancy is obtained that increases safety of the power tool. The operator can for instance control the combustion engine using a trigger 145 connected to the manually controlled throttle valve as in legacy products, and the electronically controlled throttle valve can add automated control functions to the power tool. The manually controlled throttle valve can be arranged as a mechanically controlled throttle valve linked to the trigger 145 or as a second electronically controlled throttle valve arranged to be controlled at least in part based on a state of the trigger 145.

The manually controlled throttle valve may comprise a start boost aperture configured to allow a start boost air flow to pass the manually controlled throttle valve in its closed position. This way the electronically controlled throttle valve can increase the air flow during start of the combustion engine, which is an advantage.

According to some aspects, the manually controlled throttle valve and the electronically controlled throttle valve are mechanically linked to each other, such that the position of the electronically controlled throttle valve at least partly governs the position of the manually controlled throttle valve. This mechanical linkage can be used to increase the air flow to the combustion engine during start operation, which is an advantage. The mechanical link may for instance be based on cooperating cams arranged on respective valve axes of the throttle valves, or on some other form of mechanical link structure.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIGS. 1A-B show two example power cutter designs;

FIG. 2 illustrates an example fuel system for a hand-held power tool;

FIGS. 3A-B illustrate an example fuel system for a hand-held power tool;

FIGS. 4A-B illustrate an example fuel system for a hand-held power tool; ;

FIG. 5 schematically shows a combustion engine fuel/air supply system;

FIG. 6 shows an example of an idling air supply to a combustion engine;

FIGS. 7A-B illustrate an example fuel system for a hand-held power tool;

FIGS. 8A-B show valve states during combustion engine start and idling;

FIGS. 9A-B show example valve states during combustion engine operation;

FIGS. 10A-B illustrates an electronically adjustable idling air channel;

FIG. 11 shows a system of mechanically linked throttle valves;

FIGS. 12A-B show example valve operations during engine start;

FIGS. 13A-B show other example valve operations during engine start; and

FIGS. 14A-C illustrate an example fuel system for a hand-held power tool.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

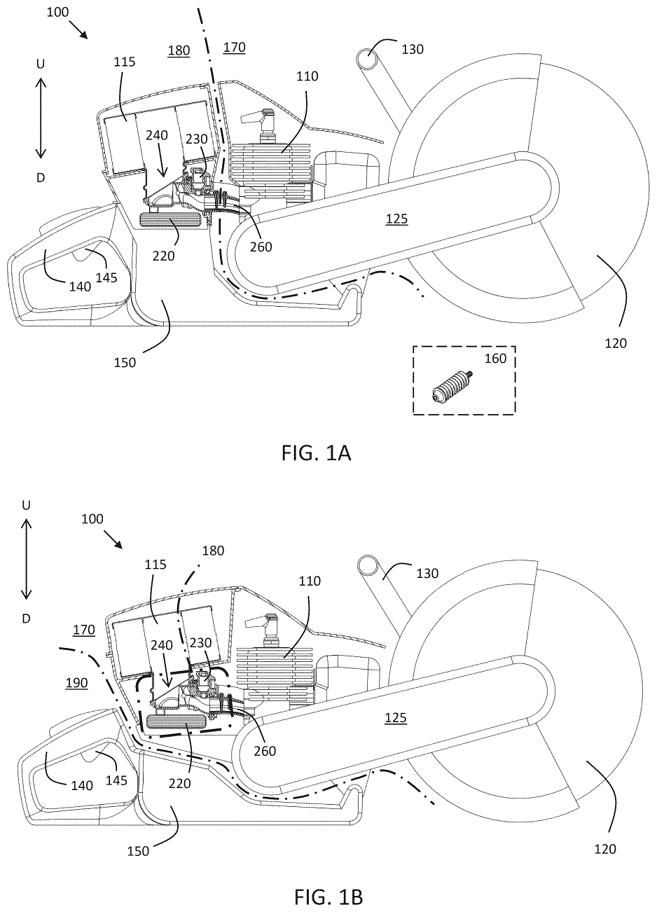

FIGS. 1A and 1B show two examples of a power cutter, which is an example of a hand-held power tool 100 for cutting hard material work objects such as concrete and stone. The techniques and arrangements presented herein are particularly suitable for use with construction equipment such as power cutters, but can also be applied in chain saws and other hand-held power tools. Thus, although the techniques disclosed herein will be primarily exemplified by a power cutter, it is appreciated that the herein disclosed techniques for providing fuel and air to a crankcase scavenged combustion engine is generally applicable also in other type of tools, such as chainsaws, hedge trimmers, and other hand-held powertools.

The power cutters in FIGS. 1A-B comprise a combustion engine 110 arranged to drive a work tool 120, here in the form of a rotatable circular abrasive cutting tool, via a drive arrangement comprised in a power cutter tool arm 125. A front handle 130 and a rear handle 140 are used by an operator to guide the machine during use. The front handle 130 extends transversal to the plane of the rotatable cutting disc, and is closer to the tool 120 compared to the rear handle 140.

A fuel tank 150 stores fuel for driving the combustion engine 110. The combustion engine 110 operates on a mixture of fuel from the fuel tank 150 and air from an air intake 240, which normally comprises an air filter 115 as illustrated in FIGS. 1A and 1B arranged to filter air to remove particles and other impurities.

In the example power cutter 100, a first mass 170 of the equipment 100 comprises the combustion engine 110 and a second mass 180 of the equipment 100 is vibrationally decoupled from the first mass 170 by means of one or more resilient members, such as the steel spring 160 shown as an insert in FIG. 1A. Rubber bushings or other types of vibration damping resilient elements can also be used to vibrationally isolate the first mass from the second mass. The distance between the first mass and the second mass is often referred to as the vibration gap and can be in the order of a centimeter or so. Techniques for vibrationally isolating two or more masses of a power tool from each other have been known for a long time, see, e.g., SE359250, and will therefore not be discussed in more detail herein.

In the example of FIG. 1A, the combustion engine 110 and the cutting tool 120 are comprised in the first mass 170 of the power cutter, while the handle parts 130, 140 are comprised in the second mass 180 (the connection between the front handle 130 and the second mass 180 is not shown in FIG. 1A). The fuel tank 150 is also part of the second mass 180 in this example.

In the example of FIG. 1B, the second mass 180 is smaller, and only comprises parts of a fuel injection system which will be discussed in the following. The handle parts 140, 130 then form part of a third mass 190 which also comprises the fuel tank 150. In this example the second mass 180 is vibrationally isolated from the first mass 170 by resilient members in the form of bushings. The third mass 190 is vibrationally isolated from the first mass, and therefore also from the second mass, by the type of steel springs 160 illustrated in FIG. 1A, or other vibration damping elements such as resilient bushings or the like.

The at least two masses 170, 180 of the power tool 100 are vibrationally isolated from each other in order to prevent vibrations generated by the combustion engine 110 and/or by the cutting tool 120 to propagate to other parts of the machine, such as the handle parts 130, 140. The example power cutters 100 also comprise electronic control units (ECU) 220, fuel injectors 230, and a conduit for guiding an air and fuel mixture to the combustion engine 110. These components will be discussed in detail below.

In both examples, the ECU 220 is located in direct connection to the air intake 240. Thus, the ECU 220 benefits from some cooling by the air flow in the air intake. The ECU 220 is also distanced from the combustion engine 110 by the vibration gap, and therefore is less effected by the heat generated by the combustion engine 110 during use of the machine.

Crankcase scavenged combustion engines are commonly used in appliances such as power cutters due to their high power-to-weight ratio and low complexity. Such engines have traditionally comprised carburettors for feeding fuel to the engine. However, fuel injection systems comprising fuel pumps and fuel injectors are becoming increasingly common. EP2602470, for instance, discloses an example crankcase scavenged two-stroke engine with fuel injection into the crankcase. It is normally desired to place the fuel injector as close as possible to the combustion chamber since this provides a faster response to changes in the fuel injection timing or fuel amount.

A problem with mounting the fuel injector close to the engine, such as directly onto the crankcase as in EP2602470, is the high temperatures that are often present at this location, and also the relatively strong vibrations generated by the combustion engine 110.

Vapor lock is a problem caused by liquid fuel that is changing state to gas while still in the fuel delivery system of the combustion engine. This may disrupt the operation of the combustion engine, and may also make restarting the combustion engine more difficult. For this and other reasons, it is desired to maintain a low temperature at the fuel injector. A reduction of fuel injector temperature can be achieved, e.g., by active cooling using a flow of air and/or by placing the fuel injector at a location distant from the heat source, i.e., the hot combustion engine. Active cooling improves operating conditions for the fuel injector system during machine operation, but the active cooling is of course not effective when the machine is turned off, when problems with residual heat transients may arise. Placing the fuel injector at a location distanced from the heat source is effective to reduce fuel injector temperature both during operation and when the machine has been turned off but has traditionally been avoided to the problems associated with the increased distance between injector location and combustion chamber.

Fuel injectors normally comprise electrical components such as mechanically precise solenoid valves with electrical wire connections that may be sensitive to prolonged exposure to vibration. Thus, it is also desired to limit the amount of vibration that the fuel injector is subject to during use.

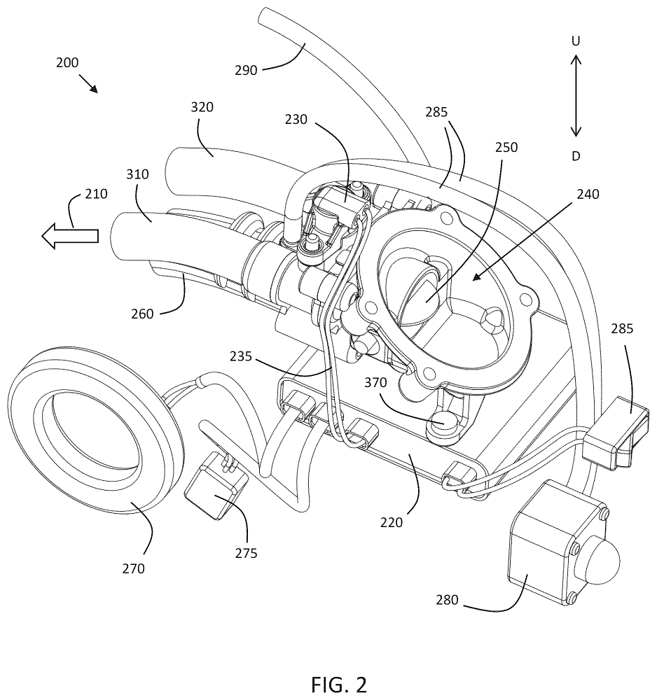

FIG. 2 shows an example fuel system 200 suitable for use with the power cutters in FIGS. 1A and 1B. A fuel injector 230 is arranged in the second mass 180, i.e., in the non-vibrating part of the power cutter, in connection to the main combustion air flow from the air intake 240. Thus, the fuel injector 230 is separated from the combustion engine 110 by the vibrationally isolating elements bridging the vibration gap between the first mass 170 and the second mass 180. This placement of the fuel injector has several benefits. First of all the fuel injector is now distanced from the hot combustion engine 110 and therefore subject to much lower temperatures compared to, e.g., a fuel injector mounted directly onto the crankcase or in the cylinder head of the engine 110. This lower temperature alleviates issues such as vapor lock. Also, the placement of the fuel injector 230 in the non-vibrating part of the power cutter means that the fuel injector, and notably also its electrical connections, are subject to much less vibration compared to if the fuel injector had been mounted in the vibrating part of the power cutter.

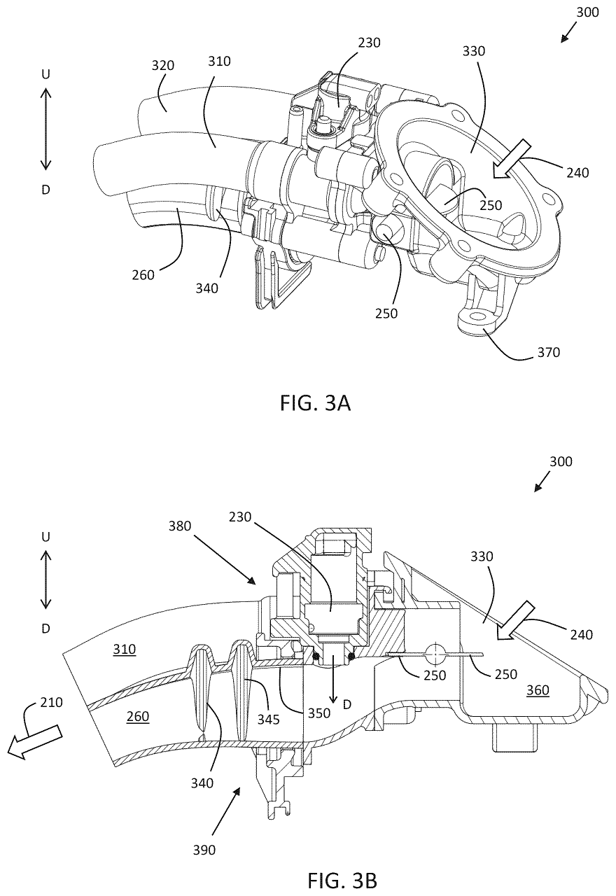

Combustion air is guided from the ambient environment via the air filter 115 and into the air intake 240. At least one throttle valve 250 is arranged in the main combustion air flow to regulate the amount of air supplied to the combustion engine 110. This throttle valve is normally controlled from the machine trigger 145 on the rear handle 140, but can also be an electronically controlled throttle valve as will be discussed in more detail below. The fuel injector 230 is arranged downstream from this throttle valve 250, where it dispenses a controlled amount of fuel into the engine air and fuel intake flow 210. A more detailed view of the fuel injector in FIG. 2 is provided in FIG. 3B and discussed below. The engine air and fuel intake flow 210 passes from the second mass 180 over to the first mass 170 partly in a non-rigid conduit 260, i.e., a rubber hose or the like, which terminates in one or more ports formed in the cylinder wall of the combustion engine 110 (not shown in the Figures).

An airhead channel, also known as an air channel for stratified scavenging, is an air channel through which clean air (without fuel) intermittently flows into the combustion chamber. During the intake period of a crankcase scavenged two-stroke combustion engine with stratified scavenging, clean air is supplied via the airhead channel or channels through ports in the cylinder wall. The flow of clean air fills the scavenging canals, filling them with air without fuel. During the same intake period, a fuel and air mixture is supplied to the crankcase via the air and fuel intake conduit. During the scavenging period of the combustion engine, the initial flow into the cylinder from the scavenging ducts is mainly clean air due to the stratified scavenging. This clean air is then followed by air with fuel from the crank case entering the combustion chamber at a later stage of the scavenging period. The late entry of fuel into the combustion chamber limits the scavenging losses of unburnt fuel into the exhaust, resulting in reduced emission from the combustion engine. There are two airhead channels 310, 320 in this example which form part of the air and fuel intake flow 210. Techniques for stratified scavenging are generally known and will therefore not be discussed in more detail herein.

To summarize, FIGS. 1A-B and FIG. 2 illustrate an example of a hand-held power tool 100 which comprises a crankcase scavenged combustion engine 110 arranged to drive a work tool 120. A first mass 170 of the equipment 100 comprises the combustion engine 110 and a second mass 180 of the equipment 100 is vibrationally decoupled from the first mass 170 by means of one or more resilient members 160. The second mass 180 may just comprise some components of the combustion engine air/fuel system as exemplified in FIG. 1B, or a larger part of the equipment as illustrated in FIG. 1A. Hence, it is appreciated that the power tool may comprise two or more masses, out of which at least the first and second masses are vibrationally isolated from each other.

A fuel injector 230, configured to provide a controlled amount of fuel into an air and fuel intake flow 210 of the combustion engine 110, is arranged in the second mass 180 and separated from the first mass 170 by the one or more resilient members. The fuel injector 230 is fed from a fuel pump 280. The air and fuel intake flow 210 of the combustion engine 110 preferably passes from the second mass 180 to the first mass 170 via a non-rigid tubular conduit 260, such as a rubber hose or the like. This non-rigid conduit reduces the amount of vibration transferred between the masses, which is an advantage. The non-rigid tubular conduit 260 also simplifies machine assembly, since many components can be assembled separately into a single sub-system, e.g., as illustrated in FIG. 2, and then integrated with the rest of the machine.

Fuel injectors are conventionally placed close to the combustion engine, i.e., directly onto the crankcase or in connection to the cylinder head of the engine. This placement is often motivated by the argument that the distance from the fuel injector to the combustion chamber should be kept as small as possible. However, locations close to the combustion engine are also associated with increased temperatures and strong vibration, which is a drawback. By placing the fuel injector 230 in the second mass 180 where it is both distanced from the combustion engine 110 and vibrationally decoupled from the combustion engine 110, the temperature of the fuel injector is reduced, and the fuel injector is better protected from strong vibration. This placement may seem counter-intuitive and contrary to good performance, since large distances between fuel injector and combustion engine have traditionally been avoided. However, in this particular case it has been found that performance degradation due to the distance between fuel injector and combustion chamber is acceptable. The length of the non-rigid tubular conduits that connect the fuel injector system to the combustion engine is on the order of a few centimeters up to 20 cm or so. The distance between the fuel injector and the combustion engine is in a preferred embodiment at least 2 cm and preferably more than 5 cm.

An additional advantage of the present fuel injection arrangements is that it enables a modular way of constructing the equipment 100. By integrating the fuel injector together with the throttle valve and inlet from the air filter, a compact fuel/air sub-system can be designed which is easy to assemble with the rest of the machine. An electronically controlled throttle valve can also be arranged in series with the manually controlled throttle valve and integrally formed with the fuel/air sub-system. This electronically controlled valve allows for more advanced optimization of the combustion engine operation, such as the functions discussed in WO2020027708A1.

According to one example discussed above, the second mass 180 of the equipment 100 comprises at least one handle 130, 140 by which an operator guides the equipment 100 during use. The first mass 170 may in this case be vibrationally decoupled from the second mass 180 by means of one or more metal springs or rubber bushings that bridge the vibration gap between the two masses. This type of vibrational decoupling is commonly seen in hand-held combustion engine powered construction equipment, where vibrations from the combustion engine 110 and/or the work tool 120 may cause discomfort or even injury to an operator of the equipment 100 if allowed to propagate in full force to the handles 130, 140. The second mass 180 may also comprise a fuel tank for storing fuel.

According to the other example discussed above, the equipment 100 further comprises a third mass 190 vibrationally decoupled from at least one of the first mass 170 and the second mass 180. The third mass 190 comprises at least one handle 130, 140 by which an operator guides the equipment 100 during use. In this case the second mass 180 may be vibrationally decoupled from the first mass by rubber bushings or other vibration damping elements holding the second mass in position relative to the first mass. The non-rigid tubular conduit 260 also acts to vibrationally decouple the second mass 180 from the first mass 170. An advantage associated with this way of assembling the complete machine is that the fuel injection system can be formed as a single sub-system, and assembled by resilient mounting together with the rest of the machine in an efficient manner.

An ECU 220 configured to control the fuel injector 230 is optionally arranged in the second mass 180. This placement of the ECU is advantageous since the ECU is hereby protected from strong vibration which could otherwise cause harm to the ECU. Also, an electric control wire extending from the ECU 220 to the fuel injector 230 can now be enclosed in the second mass, or at least its electrical connectors at the fuel injector end. Thus, electrical connectors are protected from strong vibration, and the electric control wire to the fuel injector does not have to pass in between the first mass 170 and the second mass 180. Note also that the ECU 220 is arranged in connection to the air and fuel intake flow 210 where it receives some cooling from the air, and also that the fuel injector 230 and the ECU 220 are arranged on opposite sides of the air and fuel intake flow 210, providing a compact configuration of parts. According to some aspects the ECU 220 is also arranged to generate control signals for controlling an electronically controlled throttle valve of the power tool. This electronically controlled throttle valve will be discussed in more detail below.

FIG. 2 also shows some additional components of the fuel injection system 200. A stator 270 is optionally arranged in connection to a rotor fixed to the motor axle, and thus picks up electrical energy for powering, e.g., the ECU 220 and the fuel injector 230 solenoid valve. The ECU 220 control the fuel injection process, in terms of timing and sometimes also configured the amount of fuel dispensed into the air and fuel intake flow 210, at least partly based on data received from a motor sensor 275. The motor sensor may, e.g., provide data related to combustion pressure, various temperature readings associated with the combustion engine 110, and also motor axle speed. The motor sensor data can also be used to control an electronically controlled throttle valve.

A fuel pump 280 delivers fuel at an operating pressure to the fuel injector 230. The operating pressure of the fuel pump is often fixed, but it can in some cases also be controllable from the ECU 220, thus providing additional degrees of freedom to optimize the combustion process. The fuel pressure can, for instance, be measured and the pressure information can then be used by the ECU 220 to compensate for pressure variations in the fuel feed. According to some aspects, at least one fuel line 285 extending from the fuel pump 285 to the fuel injector 230 is enclosed in the second mass 180. This means that the fuel line is protected from harmful vibration and high temperatures, since it is distanced from the combustion engine, which is an advantage. The fuel pump can also be located in the third mass 190 illustrated in FIG. 1B, in which case the fuel line passes between the third mass 190 and the second mass 180, which are both vibrationally decoupled from the first mass 170.

A stop button 285 is furthermore connected to the ECU 220, and cabling to the combustion engine ignition 290 also extends out from the ECU to the combustion engine 110.

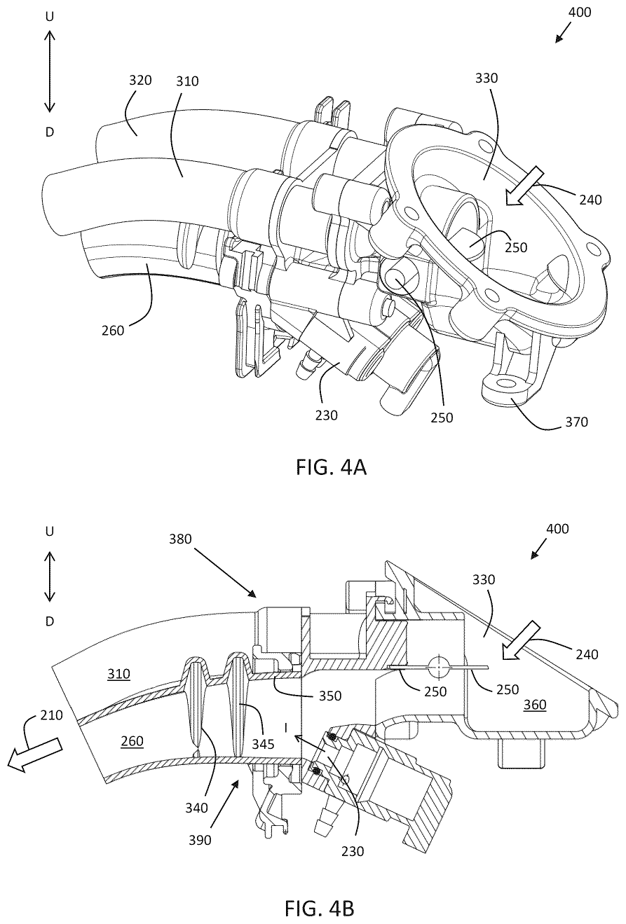

FIGS. 3A-B and FIGS. 4A-B show two examples of valve housings 300, 400 with integrated fuel injectors 230 which can be used with advantage in power tools such as power cutters, hedge trimmers, leaf blowers, and chain saws. FIGS. 3A and 4A show perspective views, while FIGS. 3B and 4B show cross-sectional views. The arrangement in FIGS. 3A and 3B resembles that shown in FIGS. 1A and 1B, while the design shown in FIGS. 4A and 4B is an alternative design where the fuel injector 230 is arranged on the downward side D of the throttle valve arrangement and the air channels.

Both example valve housings 300, 400 comprise an input aperture 330 forming part of the air intake 240 of the combustion engine system of the equipment 100. Some type of air filter is often arranged upstream of the valve housing. Example air filters 115 were discussed above in connection to FIGS. 1A and 1B. A throttle valve 250 controls the amount of air provided to the combustion engine in a known manner. It is appreciated that one or more throttle valves can be used in series or in parallel. For instance, one throttle valve can be manually controlled, and another valve can be electrically controlled from the ECU 220 to optimize the combustion engine operation during use of the equipment 100. The manually controlled throttle valves discussed herein are normally spring biased towards the closed position, such that the valve automatically closes when the operator does not actuate the trigger 145.

The fuel injector 230 can be integrated in or at least located close (within 5-30 mm) to the valve housing part together with the throttle valve 250 of the hand-held power tool 100, thus providing a compact design with high mechanical integrity, as illustrated in FIGS. 3A-B and 4A-B.

FIGS. 3A-B and 4A-B also illustrate optional airhead channels 310, 320 which extend out from the valve housing towards the combustion engine 110. An airhead channel is a channel where pure air is fed to the combustion engine 110 from the air intake 240. The airhead channels terminate in respective airhead ports formed in the cylinder wall. The placement of these airhead ports is such as to allow access from the airhead channels into the cylinder as part of the scavenging operation before the fuel and air mixture enters the cylinder, thereby reducing emission from the combustion engine 110. Airhead systems for crankcase scavenged combustion engines are generally known and will therefore not be discussed in more detail herein.

The at least one airhead channel 310, 320 extends from the second mass 180 over to the first mass 170. Notably, the fuel injector 230 is arranged in connection to the at least one airhead channel 310, 320. Thus, the relatively cool air in the airhead channel provides cooling of the fuel injector, which is an advantage since it is desired to keep the temperature of the fuel injector low.

It is also possible to configure a single airhead channel which extends from the second mass 180 over to the first mass 170. This single airhead channel may then be terminated, e.g., in a branch arranged in connection to a cylinder wall of the combustion engine 110, or in a single airhead port formed in the cylinder wall of the combustion engine 110.

The design may, as exemplified in FIGS. 3A-B and 4A-B, comprise first and second airhead channels 310, 320 extending from the second mass 180 over to the first mass 170. The fuel injector 230 is then preferably arranged in between the first and second airhead channels 310, 320, where it is both cooled and mechanically supported by the airhead channel conduits.

The fuel injector 230 illustrated in, e.g., FIGS. 3A-B and 4A-B is intersected by a vertical plane (when the equipment 100 is in a normal operating position), which plane separates the first and second airhead channels 310, 320 from each other. This plane intersects both the upper-mounted fuel injector in FIG. 3A-B and the lower mounted fuel injector in FIGS. 4A-B.

It is appreciated that the plane need not be strictly vertical. Substantial benefits are also obtained from a design with an essentially vertical separating plane, such as within 5-10 degrees from exact vertical alignment of the plane.

Said normal operating position refers to the orientation of the machine during normal use. The orientation of the machine in the normal operating position is essentially equivalent to the orientation of the machine when in rest, i.e., when the machine is not used and supported on the ground in a resting position. The machines illustrated in FIGS. 1A and 1B can be said to be in normal operating position.

The combustion engine 110 is often a single cylinder engine, with a cylinder bore for a reciprocating piston. The vertical plane normally intersects with the center axis of this cylinder bore.

The arrangement with the essentially vertical plane intersecting the fuel injector may advantageously also be used in power tool which do not comprise the two or more vibrationally isolated masses 170, 180. In other words, the present disclosure also relates to hand-held power tool 100 comprising a crankcase scavenged combustion engine 110 arranged to drive a work tool 120, wherein a fuel injector 230 of the equipment 100 is arranged upstream of and distanced from the combustion engine 110. The fuel injector may, e.g., be distanced from the combustion engine by some form of conduit, such as a rigid or a non-rigid conduit, for example the tubular conduit 260. Distanced from may mean distanced by more than 5 cm, or at least not directly attached to. The hand-held power tool 100 comprises first and second airhead channels 310, 320, e.g., as illustrated in FIG. 3A-B and in FIGS. 4A-B, arranged to guide pure air to the combustion engine 110. The fuel injector 230 is intersected by said essentially vertical plane separating the first and second airhead channels 310, 320.

According to some aspects, the fuel injector 230 is arranged above (in direction U) an air and fuel intake flow 210 of the combustion engine 110 in the normal operating position (or resting position) of the hand-held power tool 100. Said normal operating position was discussed above, it is essentially an up-right position of the equipment 100, according to the illustrations in FIGS. 1A-B.

An ECU 220 is configured to control the fuel injector 230. This ECU 220 is also intersected by the vertical plane, and it is advantageously arranged below the air and fuel intake flow 210 in the normal operating position of the hand-held power tool 100, while the first and second airhead channels 310, 320 are arranged above the fuel intake flow 210 in the normal operating position of the hand-held power tool 100.

This arrangement can of course also be complemented by vibrationally isolated first and second masses, as discussed generally herein, in which case the fuel injector 230 is preferably arranged in the second mass 180, distanced from the combustion engine 110.

There is also disclosed herein hand-held power tool 100 comprising a crankcase scavenged combustion engine 110 arranged to drive a work tool 120, wherein a fuel injector 230 of the equipment 100 is configured to provide a controlled amount of fuel into the air and fuel intake flow 210 of the combustion engine 110, where the fuel injector 230 is arranged upstream and distanced from the combustion engine 110 and substantially above the air and fuel intake flow 210 in the discussed normal operating position of the hand-held power tool 100, wherein the hand-held power tool 100 comprises at least one airhead channel 310, 320, and wherein the airhead channel 310, 320, at the position of the injector 230, is arranged substantially above the fuel intake flow 210 in the normal operating position of the hand-held power tool 100.

It is noted that the throttle valve 250 is arranged to control the air and fuel intake flow 210 and the air flow through the at least one airhead channel 310, 320, i.e., the throttle valve is a common valve for both air and fuel flow and airhead flow.

To improve the flexibility of the non-rigid conduit 260, bellow-like portions 340, 345 are arranged downstream from the valve housing. These bellow-like portions increase the flexibility of the non-rigid conduit, making it more easy to attach at its end points. The bellow-like portions 340, 345 also increase the vibrational isolation between the first and the second masses, especially if the sub-system 300, 400 is used in a design like that shown in FIG. 1B.

The fuel injector 230 in FIGS. 3A-B is mounted on an upward U side of the air and fuel intake flow 210 of the combustion engine 110, and the controlled amount of fuel is consequently injected in a downward direction D when the equipment is held in a normal operating position. This placement has the associated advantage of gravity aiding the fuel as it is injected into the air and fuel intake flow of the combustion engine 110. Alternatively, the fuel injector 230 can be mounted on a downward side D of the air and fuel intake flow 210 of the combustion engine 110, and the controlled amount of fuel be injected in a direction I having a component in the upwards direction U when the equipment 100 is held in a normal operating position, as exemplified in FIG. 4B. With reference to FIG. 1, the upward direction U is where the front handle 130 is, while the downward direction D is where the machine is supported on ground.

FIGS. 2, 3A-B and 4A-B illustrate examples of integrally formed fuel system modules 200, 300, 400 suitable for use with the type of crankcase scavenged two-stroke combustion engines discussed herein. The module comprises a number of components with complex interdependency which have been integrally formed into a single unit which is then easy to assemble with the rest of the equipment 100.

The module comprises an input aperture 330 for allowing a flow of clean air into the fuel system module. This input aperture may, e.g., be designed to interface with an air filter 115 of the equipment, or some other form of primary air intake. A central cavity 360 is optionally arranged in connection to the input aperture 360. One or more airhead channel apertures 380 are arranged to interface with respective airhead channels 310, 320 for guiding clean air out from the fuel system module. Thus, the fuel system module supports stratified scavenging. In case no stratified scavenging is desired, then these apertures may be sealed. A fuel and air mixture aperture 390 is arranged to interface with a conduit 260 for guiding a fuel and air mixture out from the fuel system module, such as the non-rigid conduit discussed above, although it does not have to be non-rigid of course. A throttle valve 250 is arranged to control the flow of clean air from the input aperture 330 to the one or more airhead channel apertures 380 and to the fuel and air mixture aperture 390. A fuel injector seat is arranged to receive a fuel injector 230, and an aperture into the conduit 260 for guiding the fuel and air mixture out from the fuel system module is formed in connection to the fuel injector seat.

This highly compact fuel system module can be assembled separately from the rest of the equipment 100 and then conveniently mounted as a single integrated module. This simplifies assembly of the complete system, which is an advantage.

The integrally formed fuel system module 200, 300, 400 optionally also comprises means 370 for attaching an ECU 220 to the fuel system module. This means that also the ECU can be pre-assembled together with the components of the fuel system to make a compact pre-assembled unit. The electrical cable harness 235 arranged inbetween the ECU 220 and a fuel injector 230 received at the fuel injector seat may then also be pre-assembled.

By the integrally formed fuel system module many of the complex fuel system components can be assembled separately from the rest of the equipment 100 and then mounted in a simple modular manner. Additional advantages are obtained if the connections to the combustion engine, i.e., the airhead channels 310, 320 and the conduit 260 is non-rigid, since a flexible conduit is more easily connected at its end points.

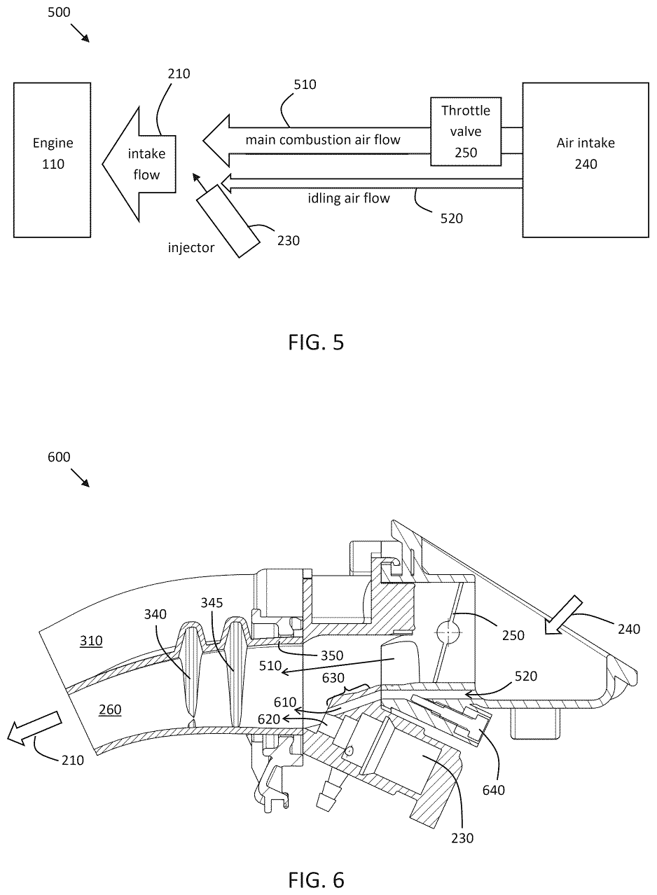

FIG. 5 schematically illustrates components of the combustion engine air and fuel intake flow 210. The purpose of the air and fuel intake flow is to provide a suitable mixture of fuel and air to the combustion chamber of the combustion engine 110. The flow starts at an air intake 240 of the machine where ambient air is drawn into the system. The ambient air is normally filtered by an air filter 115 at an early stage in order to remove particles and other impurities as exemplified in FIGS. 1A and 1B. The air intake on some machines also comprise additional air cleaning arrangements, such as centrifugal systems for separating out larger particles from the intake air. A main combustion air flow channel 510 passes via the throttle valve 250 and the flow in the main combustion air flow channel 510 is controlled by the position of the throttle valve 250. This air flow component determines the operating point of the combustion engine, as discussed in WO2020027708A1. Generally, the more air that is allowed to pass via the main combustion air flow channel 510 the higher the output power of the combustion engine 110. An idling air flow channel 520 is also provided. This air flow provides air for operating the combustion engine during idle operation, and is not controlled by the throttle valve 250. The idling air flow in the idling air flow channel 520 is normally much smaller than the main combustion air flow of the main combustion air flow channel 510 when the machine is operated at full throttle. In some cases the idling air flow is achieved by not letting the throttle valve close fully at zero throttle. The manually controlled throttle valve may for instance comprise a small aperture or be prevented from closing fully by an abutment such that an air flow larger than a desired idling air flow is permitted to pass the manually controlled throttle valve. This allows the electronically controlled throttle valve to control both idling air flow level and air flow during combustion engine start by opening and closing to regulate the air flow during different operations. However, additional advantages can be obtained by letting the idle air flow pass via a separate conduit, as will be discussed in the following.

An idling air flow channel 520 is optionally arranged to connect with the air and fuel intake flow 210 of the combustion engine 110 downstream from the throttle valve 250 in connection to the fuel injector 230 output, i.e., close to where the fuel from the fuel injector enters into the intake flow 210. According to some aspects of the present disclosure, the idling air flow is arranged to connect with the air and fuel intake flow 210 of the combustion engine 110 within 0 -10 mm of the fuel injector nozzle.

Since the idling air flow channel 520 connects with the air and fuel intake flow 210 where the nozzle of the fuel injector is located, the idling air flow from the idling air channel cools the fuel injector, thereby alleviating problems such as vapor lock and the like. Also, the idling air flow draws the fuel towards the combustion engine chamber, effectively preventing a puddle of fuel from forming in the air and fuel intake flow conduit where it can cause uneven idling of the combustion engine 110.

As shown in FIG. 6, the idling air flow channel 520 can also be guided along a part 630 of the fuel injector 230 prior to connecting with the air and fuel intake flow 210 of the combustion engine 110. The idling air flow 610 exiting the idling air flow channel 520 may as noted above also be configured to pass the output 620 of the fuel injector 230 as illustrated in FIG. 6, where it urges the fuel from the injector 230 in the general direction of the air and fuel intake flow 210, which is desired. The idling air flow passing the fuel injector transports heat away from the injector and therefore improves cooling of the injector. The fuel delivery to the combustion engine 110 is also improved since the fuel is carried efficiently into the main combustion air flow channel 510 by the idling air stream 610 from the idling air flow channel 520. The fuel injector 230 may also comprise a cooling flange portion along which the idling air flow channel 520 can be guided prior to connecting with the air and fuel intake flow 210 of the combustion engine 110.

It is noted that the idling air channel configuration relative to the location of the fuel injector can be implemented even if the fuel injector is located in the first mass 170. Thus, there is also disclosed herein power tool 100 comprising a crankcase scavenged combustion engine 110 arranged to drive a work tool 120, where a fuel injector 230 is configured to provide a controlled amount of fuel into an air and fuel intake flow 210 of the combustion engine 110, and where an idling air flow channel 520 is arranged to connect with the air and fuel intake flow 210 of the combustion engine 110 in connection to the fuel injector 230. The idling air flow channel 520 is optionally guided along a part 630 of the fuel injector 230 prior to connecting with the air and fuel intake flow 210 of the combustion engine 110. The fuel injector 230 optionally also comprises a cooling flange portion, where the idling air flow channel 520 is guided along the cooling flange portion prior to connecting with the air and fuel intake flow 210 of the combustion engine 110.

FIG. 6 also shows an idling control valve 640 arranged in the idling air flow channel 520 to adjust an air flow of the idling air channel, i.e., to calibrate the operation of the combustion engine during idling. The idling control valve 640 can of course be manually configurable. However, further advantages can be obtained if the idling control valve 640 is arranged to be adjusted based on a control signal from an ECU of the equipment 100, such as the ECU 220 discussed above. The ECU can then be configured to adjust the idling control valve 640 in dependence of a pre-configured target idling speed or the like, by measuring the motor axle speed using the motor sensor 275 discussed above in connection to FIG. 2. The idling control valve 640 is commonly referred to as an idle screw, even though it does not necessarily comprise a threaded portion.

The hand-held power tool 100 and also the integrally formed fuel system module discussed above may comprise an electronically controlled idle screw 1000 as illustrated, e.g., by the examples in FIGS. 10A-B. This electronically controlled idle screw 1000 is arranged to control an air flow in the idling air flow channel 520 based on a control signal from a control unit like the ECU 220. The ECU 220 may for instance be arranged to increase the idling air flow during start of the combustion engine in order to improve start-up performance of the combustion engine. The electronically controlled idle screw 1000 may be actuated by a solenoid or similar actuator device that is electrically controllable from the ECU 220. It may be an advantage to use the solenoid to push a spring-loaded idle screw mechanism into the closed position, i.e., away from the position associated with increased air flow in the idling air flow channel 520, since this places the electronically controlled idle screw 1000 in the position associated with increased air flow when the solenoid is without power, as it normally is before the power tool 100 is started.

The idling air flow arrangement illustrated in FIG. 6 is optionally comprised in the integrally formed fuel system module discussed above. The idling air flow arrangement illustrated in FIGS. 10A-B is also optionally comprised in the integrally formed fuel system module discussed above. The idling air flow adjustment arrangements discussed herein are possible to use separately with advantage also without the other technical features disclosed herein.

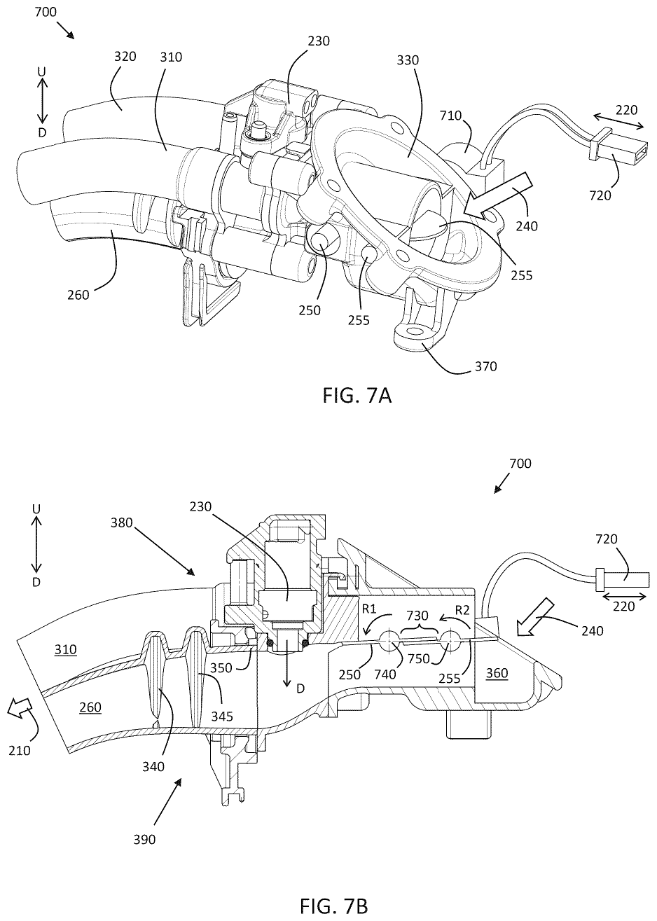

WO2020027708A1 discussed several technical functions and features that can be implemented if an electronically controlled throttle valve is added to a combustion engine air and fuel system. The features discussed in WO2020027708A1 are also applicable here. For instance, FIG. 7 illustrates an example fuel system 700 that comprises an electronically controlled throttle valve 255 arranged to control the air and fuel intake flow 210 based on a control signal from the ECU 220 or from some other throttle controller in the system. The electronically controlled throttle valve 255 may be used as the only throttle valve in the fuel system, or in series with a manually controlled throttle valve 250 to control the air and fuel intake flow 210 to the combustion engine 110. An example fuel system comprising a manually controlled throttle valve 250 in series with an electronically controlled throttle valve 255 is illustrated in FIG. 7B. Having one manually controlled throttle valve in series with an electronically controlled throttle valve in this manner increases reliability.

A servo or other electric actuator 710 can be used to control the state of the electronically controlled throttle valve 255. This actuator 710 is then connected to the ECU 220 or to some other control unit via electric cable 720. The cable 720 may, e.g., extend to an ECU 220 mounted in connection to the fuel system, as illustrated in FIG. 2. The electronically controlled throttle valve 255 may be arranged as a continuously controllable valve where the opening can be controlled continuously from a closed position to a fully open position (or between other extreme points of the valve, such as a semi-closed and a semi-open valve position). The electronically controlled throttle valve 255 may also be arranged as a discrete step controllable valve that can be controlled in steps from a closed position to an open position. Some electronically controlled valves only have two states-fully open or fully closed. Note that the valve discs in FIG. 7B are overlapping 730, i.e., the distance between the valve axes 740, 750 of rotation is less than the diameter of the valve discs. This is a spatially efficient way to install two valves in series. The valve discs in FIG. 7B are shown in their fully open position, and rotate counterclockwise to their fully closed positions, as indicated by the arrows R1, R2 in FIG. 7B. The manually controlled throttle valves in the examples in FIGS. 12A-B and 13A-B are biased towards the closed position, as customary for manually controlled throttle valves in this kind of equipment.

During start of the combustion engine 110 from standstill it may be desired to provide a bit of extra air in the air and fuel intake flow 210. Then, once the combustion engine has started up and is running properly, this extra amount of air can be removed and the combustion engine reverts back to operating on the nominal idling air flow as configured, e.g., by the idle screw 640 or by a combination of aperture in the manually controlled throttle valve and adjustment of the electronically controlled throttle valve.

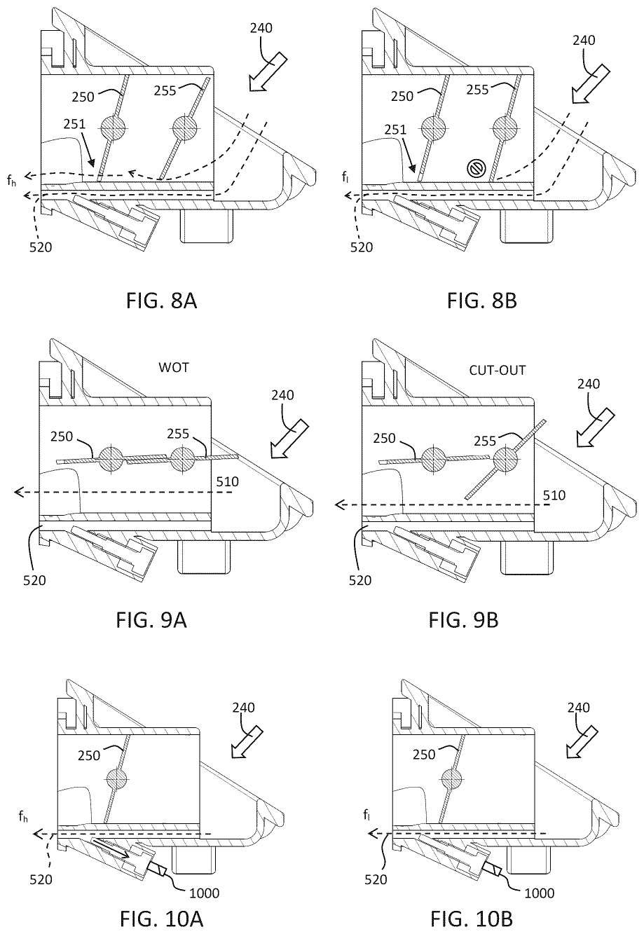

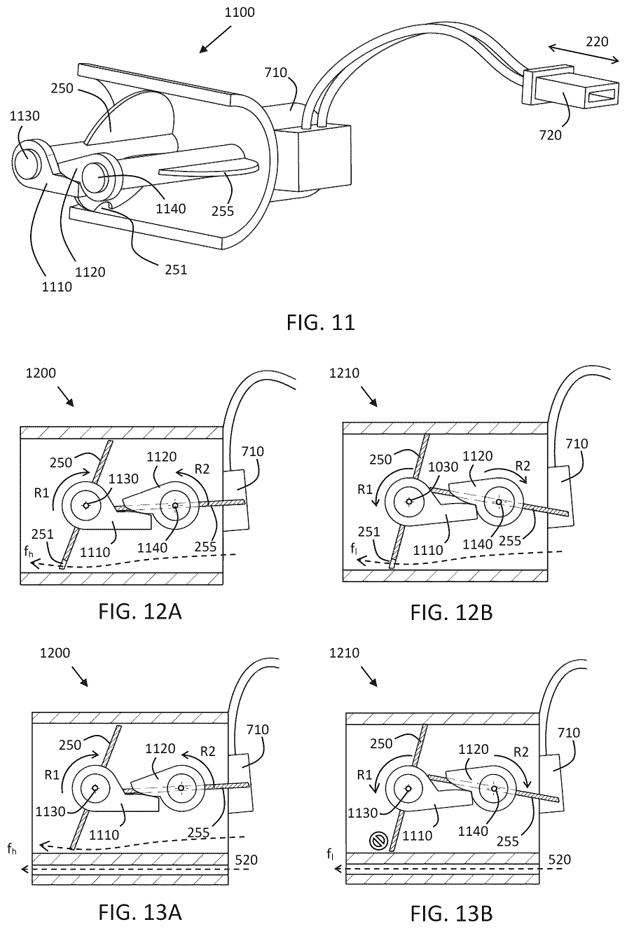

According to some aspects, the manually controlled throttle valve 250 comprises a start boost aperture 251 as exemplified in FIGS. 8A and 8B, and more clearly seen in the example shown in FIG. 11. This start boost aperture 251 is configured to allow a start boost air flow fₕ to pass the manually controlled throttle valve 250 in its closed position. The start boost air flow fₕ is the total air flow through the fuel system during combustion engine start, and it is larger than the nominal idling air flow. Since the manually controlled throttle valve 250 always allows the start boost air flow to pass, the idling air flow can be increased temporarily by the electronically controlled throttle valve 255. This concept can be used with or without a separate idling air flow channel 520. Consequently, the ECU 220 or some other control unit can be arranged to control the electronically controlled throttle valve 255 to increase the air and fuel intake flow 210 during start of the combustion engine 110, by opening up the electronically controlled throttle valve 255 as shown in FIG. 8A. Once the combustion engine has started up properly and is running smoothly, the electronically controlled throttle valve 255 can be closed again, whereupon the air flow decreases to the nominal idling air flow fₗ<fₕ and the combustion engine 110 reverts back to the configured idling operation, as illustrated in FIG. 8B.

The ECU 220 may also be arranged to increase the air and fuel intake flow 210 above an idling air flow level solely by the electronically controlled throttle valve 255 during start of the combustion engine 110, e.g., if the fuel system only comprises a single electronically controlled throttle valve and no manually controlled throttle valve in series with the electronically controlled throttle valve.

The ECU 220 can also be arranged to restrict the air and fuel intake flow 210 by the electronically controlled throttle valve 255 in case the combustion engine 110 speed does not meet an engine speed acceptance criterion, i.e., to perform a cut-out operation in order to reduce combustion engine speed to a value below a maximum speed threshold or the like. In FIG. 9A the fuel system is operated at wide open throttle (WOT) where both the manually controlled and the electronically controlled throttle valves are fully open. In FIG. 10A the air flow in the main combustion air flow channel 510 has been reduced in FIG. 9B, e.g., to bring down the speed of the combustion engine 110. This cut-out function was discussed at length in WO2020027708A1 and will therefore not be discussed in more detail herein.

FIG. 11 illustrates an example fuel system where the manually controlled throttle valve 250 and the electronically controlled throttle valve 255 are mechanically linked to each other 1100, such that the position of the electronically controlled throttle valve 255 at least partly governs the position of the manually controlled throttle valve 250. It is appreciated that this mechanical linkage between the two valves can be achieved in a number of different ways. The example mechanical link between the manually controlled throttle valve 250 and the electronically controlled throttle valve 255 in FIG. 11 comprises cooperating cams 1110, 1120 arranged on respective valve axes 1130, 1140 of the manually controlled throttle valve 250 and the electronically controlled throttle valve 255. These cams engage to force the position of the manually controlled throttle valve away from the fully closed state (to which is it biased).

The example mechanical link is arranged to force the manually controlled throttle valve 250 into a partially open position when the electronically controlled throttle valve 255 is in a first open position 1200, as illustrated in FIGS. 12A and 13A, where the first open position is a fully open position or almost fully open position of the electronically controlled throttle valve 255. The example mechanical link is also arranged to allow the manually controlled throttle valve 250 to enter a closed position when the electronically controlled throttle valve 255 is in a second open position 1210, as illustrated in FIGS. 12B and 13B, where the second open position is a partly open position of the electronically controlled throttle valve 255. It is noted that the opening difference of the electronically controlled throttle valve 255 between the operating positions 1200 and 1210 is normally quite small and somewhat exaggerated in the drawings.

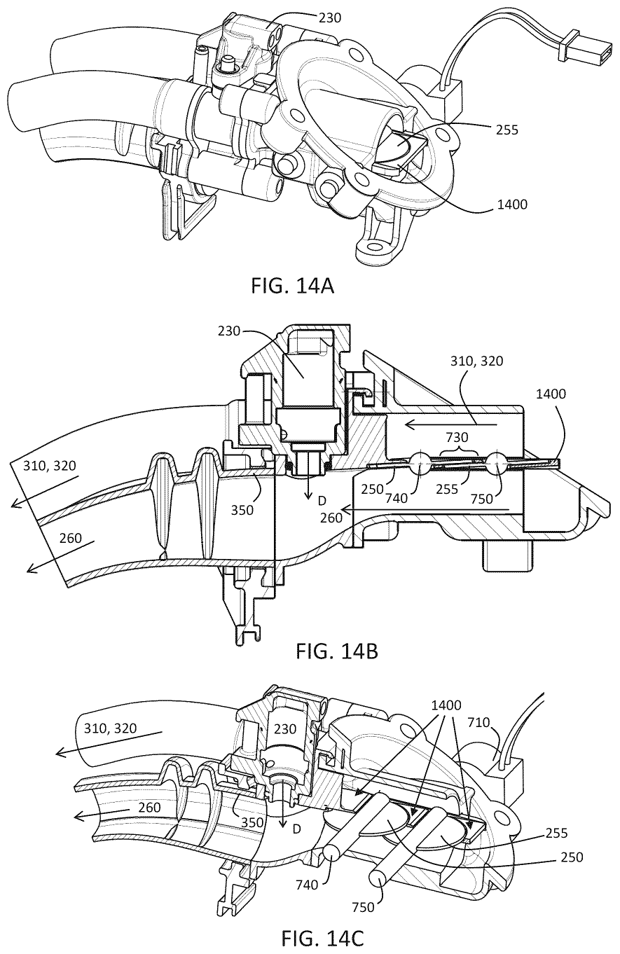

FIGS. 14A-C show an example fuel system that resembles some of the fuel system modules described above, where a manually controlled throttle valve 250 is arranged in series with an electronically controlled throttle valve 255, and where the fuel injector 230 is located downstream from both throttle valves 250, 255. In this example the throttle valves control air intake to the airhead channels and also air intake to the main combustion air flow channel.

A first separating wall 1400 is arranged in connection to the manually controlled throttle valve 250 and the electronically controlled throttle valve 255 to separate the at least one airhead channel 310, 320 from the main combustion air flow channel 510. This first separating wall prevents fuel from escaping from the main combustion air flow channel and into the airhead channels. The fact that the fuel injector 230 is arranged downstream from the throttle valves also prevents fuel from entering into the airhead channels.

In most examples discussed herein, the fuel injector is arranged downstream from the manually controlled throttle valve also downstream from the electronically controlled throttle valve. This is an advantage since it reduces the amount of fuel that leaks into the airhead channel or channels. It may also reduce problems with back-spit. The fuel injector is also in most of the examples arranged upstream and distanced from the combustion engine, i.e., the fuel injector is not arranged to inject fuel directly into the crankcase or into the combustion chamber.

Most of the example hand-held power tools discussed herein also comprise a second separating wall arranged in connection to and downstream from the fuel injector 230, between the at least one airhead channel 310, 320 and the main combustion air flow channel 510, as illustrated in many of the drawings. The second separating wall 350 effectively prevents fuel from the fuel injector 230 from entering into the at least one airhead channel 310, 320.

The present disclosure, has in general terms, described and exemplified a hand-held power tool 100 comprising a crankcase scavenged combustion engine 110 arranged to drive a work tool 120, where a fuel injector 230 is configured to provide a controlled amount of fuel into an air and fuel intake flow 210 of the combustion engine 110, as discussed above. The power tool 100 comprises an electronically controlled throttle valve 255 arranged to control the air and fuel intake flow 210 based on a control signal from an ECU 220, arranged in series with a manually controlled throttle valve 250, where the fuel injector 230 is arranged downstream from the manually controlled throttle valve 250 and the electronically controlled throttle valve 255.

According to aspects, the electronically controlled throttle valve 255 and the manually controlled throttle valve 250 are each arranged to control an air flow in a main combustion air flow channel 510 and an air flow in one or more airhead channels 310, 320. This throttle valve arrangement is thus configured for stratified scavenging, where both throttle valves affect the air flow in the main combustion air flow channel and also in the airhead channel or channels. An optional first separating wall 1400 may be arranged in connection to the manually controlled throttle valve 250 and the electronically controlled throttle valve 255 to separate at least one airhead channel 310, 320 from the main combustion air flow channel 510. This first separating wall improves the separation between the air head channel or channels, and the main combustion air flow channel. A fuel injector 230 is preferably arranged downstream from the manually controlled throttle valve 250 and the electronically controlled throttle valve 255.

1. A hand-held power tool comprising a crankcase scavenged combustion engine arranged to drive a work tool,
wherein a first mass of the equipment comprises the combustion engine,
wherein a second mass of the equipment is vibrationally decoupled from the first mass by means of one or more resilient members,
wherein a fuel pump is arranged to deliver fuel to a fuel injector,
wherein the fuel injector is configured to provide a controlled amount of the fuel into an air and fuel intake flow of the combustion engine,
wherein the fuel injector is arranged in the second mass and thus separated from the first mass by the one or more resilient members.

2. The hand-held power tool according to claim 1, wherein the second mass of the equipment comprises at least one handle by which an operator guides the equipment during use.

3. The hand-held power tool according to claim 1, wherein the equipment further comprises a third mass vibrationally decoupled from at least one of the first mass and the second mass, wherein the third mass comprises at least one handle by which an operator guides the equipment during use.

4. The hand-held power tool according to claim 1, wherein the air and fuel intake flow of the combustion engine passes from the second mass to the first mass via a non-rigid tubular conduit.

5. The hand-held power tool according to claim 1, wherein the fuel injector is integrated in a valve housing part together with a throttle valve of the hand-held power tool.

6. The hand-held power tool according to claim 1, wherein at least one airhead channel extends from the second mass over to the first mass, and preferably the fuel injector is arranged in connection to the at least one airhead channel.

7. The hand-held power tool according to claim 6, comprising first and second airhead channels extending from the second mass over to the first mass, wherein the fuel injector is arranged in between the first and second airhead channels.

8. The hand-held power tool according to claim 6, wherein a common throttle valve is arranged to control the air and fuel intake flow and the air flow through the at least one airhead channel.

9. The hand-held power tool according to claim 1, wherein the fuel injector is mounted on an upward side of the air and fuel intake flow of the combustion engine, wherein the controlled amount of fuel is injected in a downward direction when the equipment is held in a normal operating position.

10. The hand-held power tool according to claim 1, wherein the fuel injector is mounted on a downward side of the air and fuel intake flow of the combustion engine, wherein the controlled amount of fuel is injected in a direction having a component in the upwards direction when the equipment is held in a normal operating position.

11. The hand-held power tool according to claim 1, wherein an electronic control unit, ECU, configured to control the fuel injector is arranged in the second mass.

12. The hand-held power tool according to claim 1, wherein an idling air flow channel is arranged to connect with the air and fuel intake flow of the combustion engine downstream from the throttle valve and in connection to the fuel injector.

13. The hand-held power tool according to claim 1, comprising an electronically controlled throttle valve arranged to control the air and fuel intake flow based on a control signal from an ECU.

14. The hand-held power tool according to claim 13, wherein the electronically controlled throttle valve is arranged in series with a manually controlled throttle valve to control the air and fuel intake flow to the combustion engine.

15. The hand-held power tool according to claim 1, wherein the power tool is a power cutter and wherein the work tool is a rotatable abrasive cutting disc, or wherein the power tool is a chain saw and wherein the work tool is a saw chain.

16. An integrally formed fuel system module for a crankcase scavenged two-stroke combustion engine, the module comprising
an input aperture for allowing a flow of clean air into the fuel system module,
one or more airhead channel apertures arranged to interface with respective airhead channels for guiding clean air out from the fuel system module,
a fuel and air mixture aperture arranged to interface with a conduit for guiding a fuel and air mixture out from the fuel system module,
a throttle valve arranged to control the flow of clean air from the input aperture to the one or more airhead channel apertures and to the fuel and air mixture aperture, and
a fuel injector seat arranged to receive a fuel injector, wherein an aperture into the conduit for guiding the fuel and air mixture out from the fuel system module is formed in connection to the fuel injector seat.

17. The integrally formed fuel system module according to claim 16, further comprising means for attaching an electronic control unit, ECU, to the fuel system module.

18. The integrally formed fuel system module according to claim 17, further comprising an electrical cable harness arranged inbetween the ECU and a fuel injector received at the fuel injector seat.

19. The integrally formed fuel system module according to claim 16, comprising an electronically controlled throttle valve arranged to control the flow of clean air based on a control signal from an ECU.

20. The integrally formed fuel system module according to claim 19, wherein the electronically controlled throttle valve is arranged in series with a manually controlled throttle valve to control the flow of clean air.
